(19) United States
(12) Patent Application Publication
(10) Pub. No.: US 2012/0249364 A1
(43) Pub. Date: Oct. 4, 2012

(54) Method of radar emission-reception

(75) Inventors: Nicolas BON, Brest (FR); Jean-Michel QUELLEC, Ploumoguer (FR)

(73) Assignee: THALES, Neuilly-sur-Seine (FR)

(21) Appl. No.: 13/339,887

(22) Filed: Dec. 29, 2011

(30) Foreign Application Priority Data
Dec. 30, 2010 (FR) 1005183

(51) Int. Cl. G01S 13/00

(52) U.S. Cl. 342/201

(57) ABSTRACT

A radar emission-reception method including a step of cyclic emission of a group of pulses of different frequency, each frequency being emitted on a different channel and each cycle comprises a single emission phase and a single listening phase and a reception step during which the echoes of each emitted pulse are processed simultaneously and in parallel in different reception frequency channels. Also, a radar making it possible to implement the emission-reception method.

The present invention pertains to a radar emission-reception method.

An emission-frequency-agile pulse radar emits pulses with a certain repetition period denoted Tr and a certain cycle period Tc. The agility of the emission frequency is of particular interest, since it makes it possible to decorrelate the signals and thus to have better behaviour in relation to the fluctuations of the equivalent radar cross-section.

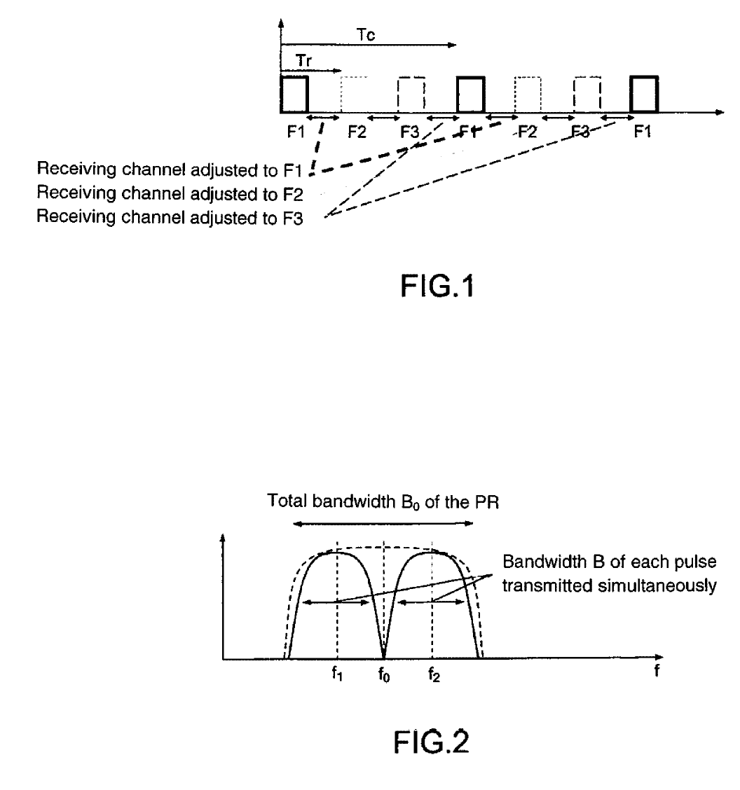

The ambiguous distance Dₐ of a radar corresponds to the minimum time between two pulses emitted at the same frequency. In the case of the waveform shown diagrammatically in FIG. 1, it corresponds to the cycle period T_{c}.

The instrumented range Dᵢ of the radar corresponds to the recurrence period Tᵣ. It is the period during which reception is ensured on the same frequency channel as that used on emission or listening period.

The two distances cited hereinabove are given respectively by:

$${D}_{n} = \frac{{cT}_{c}}{2} and {D}_{i} = \frac{{cT}_{r}}{2}$$

where c is the propagation speed of the waves used in the medium of interest. The choice of the repetition period is made according to the application that it is desired to give to the waveform of the radar (short-range, long-range detection, marine, aerial, mobile targets, etc.).

The period of a cycle also determines the maximum speed that the radar can measure without ambiguity.

An aim of the present invention is to propose a radar emission-reception method making it possible to increase the instrumented distance of the said radar, and more particularly of a waveform with frequency agility, while maintaining the ambiguous speed and the advantages related to frequency agility, and to extend the detection zone without modifying the behaviour of the processing operations in relation to the Doppler of the targets and their fluctuations.

For this purpose, the subject of the invention is a radar emission-reception method comprising:
a step of cyclic emission of a group of pulses of different frequency, each frequency being emitted in a different channel and each cycle comprises a single emission phase and a single listening phase,
and a reception step during which the echoes of each emitted pulse are processed simultaneously and in parallel in different reception frequency channels.

According to a first aspect of the invention, the method is characterized in that each of the pulses is emitted simultaneously, and in that on reception, the echoes of the pulses are processed simultaneously and in parallel in frequency channels corresponding to their spectral spreading centred on their emission frequency, each of the echoes being substantially centred on a different emission frequency.

According to another aspect of the invention, the pulses of different frequencies are emitted one after another so as to prevent the emitter from producing spurious signals originating from interference between the various emission frequencies, and on reception, the received echoes of the emitted pulses are temporally aligned with the various frequencies.

According to another particular feature of the invention, the pulses are emitted with frequency agility.

Another aim of the invention is to propose a radar able to implement the methods of the invention.

For this purpose the subject of the invention is a radar comprising an emission-reception antenna, an emission pathway and a reception channel, the said radar being characterized in that:

the emission pathway comprises a pulse generator, a first mixer, a circulator and a pilot for generating frequency channels, the said pilot generating several frequency channels simultaneously,

the reception channel comprises a second mixer linked to the said pilot and to devices for processing reception signals and a combining device, the reception channel comprising at least two processing pathways each comprising a filter tuned onto a single frequency and a processing device tuned to the frequency of the corresponding filter, the outputs of these reception pathways being linked to a combining device.

The present invention will be better understood on reading the detailed description of an embodiment, taken by way of nonlimiting example and illustrated by the appended drawing in which:

FIG. 1, cited hereinabove, is a simplified timechart of the pulses emitted by a frequency-agility radar,

FIG. 2 is a frequency diagram of an exemplary envelope of the spectrum of a radar pulse emitted in accordance with the invention,

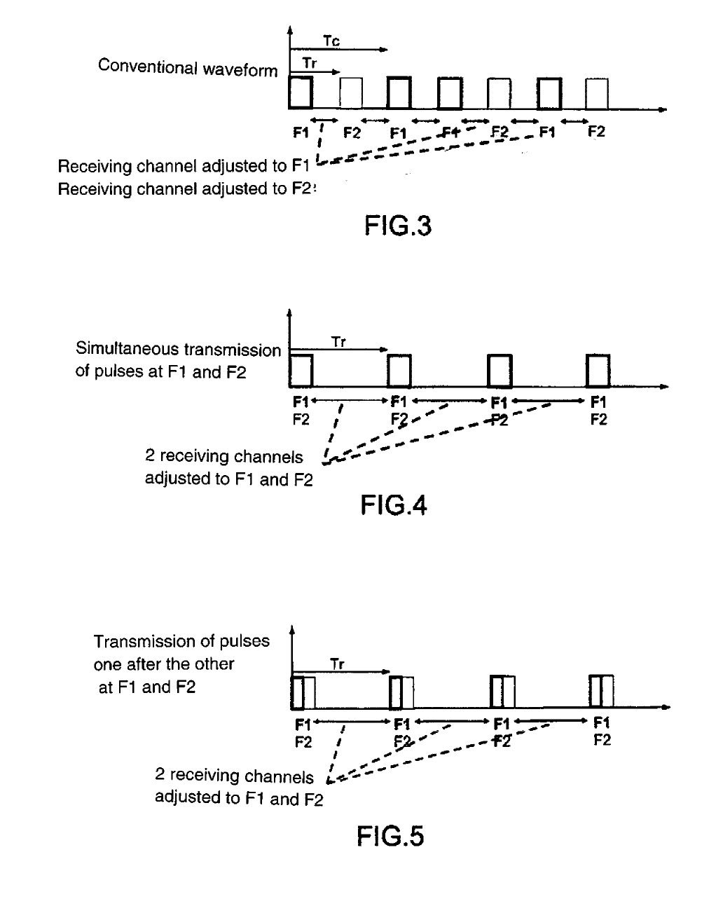

FIG. 3 is a timechart of a conventional radar waveform,

FIG. 4 is a timechart of an example of a waveform emitted by a radar in accordance with a mode of implementation of the method of the invention,

FIG. 5 is a timechart of an example of a waveform emitted by a radar in accordance with another mode of implementation of the method of the invention, and

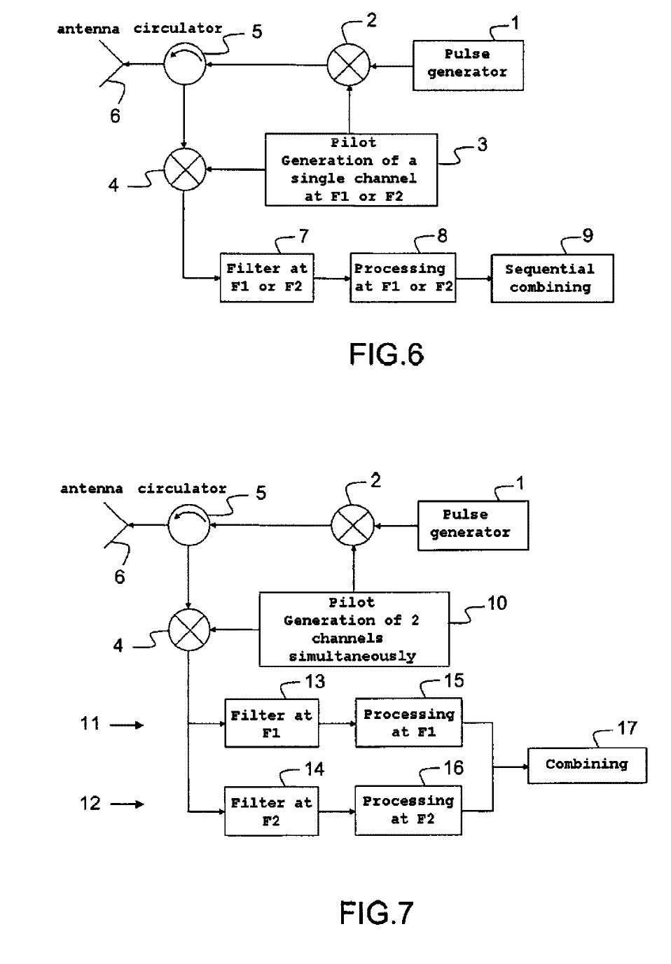

FIGS. 6 and 7 are respectively a simplified diagram of a conventional radar and of an exemplary embodiment of a radar in accordance with the invention.

The present invention is set forth in detail hereinbelow with reference to the emission of a train of pulses at two frequencies, but of course it also applies to cases of more than two frequencies.

A pulsed radar emits time-limited pulses of high power. So as to increase their passband, these signals may be modulated with a phase modulation (by a phase code) or frequency modulation (by a frequency ramp).

In a preferential manner, a frequency ramp (or chirp as it is called) is used to linearly modulate the pulses frequency-wise, this type of modulation making it possible to have a much greater compression rate.

The pulses emitted by a radar can therefore be modulated in phase (by a phase code) or linearly in frequency (shape of a “chirp”). These pulses have a given spectrum which has a certain width B which will define a channel at reception. This frequency band B will also determine the distance resolution Δr of the radar such that:

$$Δ r = \frac{c}{2 B}$$

The band of the pulses of a radar, and therefore its distance resolution, is chosen in accordance with the radar mode (for example: fine resolution for the modes relating to radar imaging or detection of small targets, less good resolution for modes relating to detection of big targets).

The principle of the invention consists in using a receiver pilot (PR) allowing a larger global band B₀ than that required by the application, and to programme it to emit pulses consisting of the sum of N pulses of smaller band B and which do not overlap frequentially so as to be able to separate these N pulses by filtering (or to modify an existing receiver so as to obtain these characteristics). An exemplary representation of the envelope of the spectrum of a pulse emitted with this principle is represented in FIG. 2 for N=2.

In a preferential embodiment, the sum (N.B) of the elementary bands of the pulses, optionally modulated in frequency (cf. chirp) or in phase (cf. phase code), is chosen in such a way that it is less than the band of the PR (receiver pilot) plus a certain margin ensuring that the spectra of the pulses do not overlap and that the rejection of the reception filters is sufficient.

On reception, N reception pathways (from a hardware or processing point of view) are constructed, each adapted to the reception of the echoes of each of the elementary pulses.

FIGS. 3 and 4 illustrate differences between the waveform obtained according to the invention (FIG. 4) and the conventional waveform (FIG. 3) in the case of agility on two frequencies.

In the conventional case, the pulses are emitted alternately at the frequency F1 and at the frequency F2 for example in accordance with a regular cycle or in accordance with a random cycle as illustrated in FIG. 4. Thus, each emission-reception cycle of cycle period Tc is composed of as much listening phase and emission phase as frequency to be emitted.

In a different manner, according to the invention, at each period Tr a group of pulses of different frequencies is emitted, each frequency being emitted in a different channel. Each emission-reception cycle of period Tr comprises just a single emission phase and just a single listening phase. In an advantageous manner, this emission-reception configuration makes it possible to obtain a larger listening period with respect to the conventional configuration and therefore makes it possible to increase the instrumented range of the radar.

As may be noted, the solution of the invention makes it possible to maintain the same cycle frequency and therefore the same ambiguous speed, and also to double the instrumented distance.

From a hardware point of view, it may be necessary to emit the pulses of different frequencies one after another so as to prevent the emitter from producing spurious signals originating from interference between the various emission frequencies. FIG. 5 illustrates this other mode of implementation of the emission-reception method according to the invention. In this case, on reception, a processing module is charged with temporally aligning the received echoes of the emitted pulses with the various frequencies.

In these two modes of implementation of the method, during the reception step, the echoes of each emitted pulse are processed simultaneously and in parallel in different reception frequency channels.

The two schematic diagrams of FIGS. 6 and 7 illustrate the principle of the radar respectively with a single reception channel and two reception frequency channels.

The radar of FIG. 6 essentially comprises: a pulse generator 1 linked to an emission pathway first mixer 2 receiving on the other hand a pilot 3 sequentially producing pulses at the frequency F1 and then F2. This pilot 3 is also linked to a reception pathway second mixer 4. The mixers 2 and 4 are linked to a circulator 5, itself linked to an emission-reception antenna 6. The output of the mixer 4 is linked to a filter 7, also operating sequentially at F1 and F2, and followed by circuits 8 for processing at these same frequencies, and which are linked to a sequential combining device 9.

In the diagram of FIG. 7 representing a radar in accordance with the invention, the elements similar to those of FIG. 6 are assigned the same numerical references as those of the elements of the diagram of FIG. 6, namely the elements 1, 2, 4, 5 and 6. The main difference resides in the fact that the pilot for generating pulses, referenced 10, simultaneously produces two channels, at the frequencies F1 and F2. It follows from this that the output of the mixer 4 is linked to two similar processing pathways 11 and 12 each comprising a filter 13, 14 respectively (at the frequency F1 for the pathway 11 and F2 for the pathway 12) followed by a processing device 15, 16 respectively (at the frequency F1 for the pathway 11 and F2 for the pathway 12). The processing operations performed by the devices 15 and 16 are generally post-integration processing operations well known to the person skilled in the art. The outputs of the devices 15 and 16 are linked to a combining device 17. All the circuits of FIG. 7 being of type known per se, their adaptation for the invention, when necessary, is obvious to the person skilled in the art on reading the present description, and will therefore not be detailed here. Likewise, the exemplary embodiment of the radar has been presented with two reception channels. Of course, this example is wholly non-limiting and a generalization to a greater number of reception channels, as a function of the number of pulses of different frequency that are emitted, is possible.

1. A radar emission-reception method comprising:
a step of cyclic emission of a group of pulses of different frequency, each frequency being emitted in a different channel and each cycle comprising a single emission phase and a single listening phase; and
a reception step during which echoes of each emitted pulse are processed simultaneously and in parallel in different reception frequency channels.

2. The method according to claim 1, in which each of the pulses is emitted simultaneously, and in that on reception, the echoes of the pulses are processed simultaneously and in parallel in frequency channels corresponding to their spectral spreading centred on their emission frequency, each of the echoes being substantially centred on a different emission frequency.

3. The method according to claim 1, in which the pulses of different frequencies are emitted one after another so as to prevent the emitter from producing spurious signals originating from interference between the various emission frequencies, and in that on reception, the received echoes of the emitted pulses are temporally aligned with the various frequencies.

4. The method according to claim 1, in which the pulses are emitted with frequency agility.

5. The method according to claim 2, in which the pulses are emitted with frequency agility.

6. The method according to claim 3, in which the pulses are emitted with frequency agility.

7. A radar configured to implement the method according to claim 1, comprising:
an emission-reception antenna;
an emission pathway comprising
a pulse generator,
a first mixer,
a circulator, and
a pilot for generating frequency channels, the said pilot generating several frequency channels simultaneously; and
a the reception channel comprising
a second mixer linked to the said pilot and to devices for processing reception signals, and
a combining device,
at least two processing pathways each comprising a filter tuned onto a single frequency and a processing device tuned to the frequency of the corresponding filter, the outputs of these processing pathways being linked to a combining device.
